(19) United States
(12) Patent Application Publication
(10) Pub. No.: US 2011/0229165 A1
(43) Pub. Date: Sep. 22, 2011

(54) IMAGE FORMING APPARATUS

(75) Inventors: Hiroyuki MAEDA, Toyokawa-shi (JP); Taiichi OMINAMI, Chiryu-shi (JP); Shigeki YAMAMOTO, Toyokawa-shi (JP)

(73) Assignee: Konica Minolta Business Technologies, Inc., Chiyoda-ku (JP)

(21) Appl. No.: 13/046,198

(22) Filed: Mar. 11, 2011

(30) Foreign Application Priority Data
Mar. 19, 2010 (JP) 2010-063934

(51) Int. Cl. G03G 15/00; G03G 15/02; G03G 15/043; G03G 15/06; G03G 15/01

(52) U.S. Cl. 399/38; 399/301; 399/50; 399/51; 399/55

(57) ABSTRACT

An image forming apparatus has a job-content recognition device for judging whether a number inputted as the number of print copies to be made is larger or smaller than a predetermined reference value; a print-data recognition device for judging whether or not inputted print data include image data and/or graphic data; and a control device for controlling executions of image stabilization control in a printing section. The control device sets a predetermined period as intervals among executions of the image stabilization control, and sets a period shorter than the predetermined period as the intervals among executions of the image stabilization control when the number inputted as the number of print copies to be made is larger than the predetermined reference value and also the inputted print data include image data and/or graphic data.

This application is based on Japanese Patent Application No. 2010-063934 filed on Mar. 19, 2010, the content of which is incorporated herein by reference.

### BACKGROUND OF THE INVENTION

1. Field of the Invention

The present invention relates to an image forming apparatus and more particularly relates to an electrophotographic image forming apparatus, such as a copying machine and a printer.

2. Description of Related Art

In an electrophotographic image forming apparatus, such as a copying machine and a printer, the amounts of electric charge of toner and the sensitivity of a photosensitive member varies depending on the frequency of executing a printing operation, the way of toner consumption, the conditions in the apparatus and the ambient environments such as the temperature and the humidity. To cope therewith, an image forming apparatus of this type executes image stabilization control periodically. In the image stabilization control, a test pattern is formed on a photosensitive member or an intermediate transfer member under predetermined conditions, and the density of the test pattern is checked. Then, the charge potential, the development bias potential and the exposure amount are adjusted so as to attain a predetermined density.

Generally, the intervals among executions of the aforementioned image stabilization control is preferably long. This is because an execution of the control causes extra toner consumption and also prevents an execution of a printing operation. However, if the image stabilization control is executed at too long intervals, it may not be possible to achieve stable image forming performance. Even with the same changes in the amount of charge of toner and in the sensitivity of the photosensitive member, the remarkableness of the change in density to users depends on the type of the image. The change in density is more remarkable in medium tone portions than in solid portions and in character portions. Especially in medium tone portions expressed by a plurality of colors, the change in density is recognized as a change in color.

When the number of sheets to be printed in a single job is small, the amount of charge of toner and the sensitivity of the photosensitive member are less likely to change during the job. However, when the number of sheets to be printed in a single job is large, the amount of charge of toner and the sensitivity of the photosensitive member change largely, thereby causing a change in color. Here, the term “job” refers to a series of processes for making an inputted number of copies in accordance with inputted print data.

JP-A No. 2008-76867 discloses that the intervals among executions of image-density check and density adjustment is changed depending on the coverage of documents to be printed. However, there are cases wherein changes in density are not remarkable because the print data include mainly characters and cases wherein high picture quality is not always required. Therefore, if the control of the intervals among executions of image-density check and density adjustment is only based on the parameter, that is, the coverage of documents to be printed, the change in the intervals may rather cause an increase in toner consumption, decreases in the lives of image-forming elements and degradation of printing productivity.

### SUMMARY OF THE INVENTION

It is an object of the present invention to provide an improved image forming apparatus.

An image forming apparatus according to an aspect of the present invention comprises: a job-content recognition device for judging whether a number inputted as the number of print copies to be made is larger or smaller than a predetermined reference value; a print-data recognition device for judging whether or not inputted print data include image data and/or graphic data; and a control device for controlling executions of image stabilization control in a printing section; wherein the control device sets a predetermined period as intervals among executions of the image stabilization control, and sets a period shorter than the predetermined period as the intervals among executions of the image stabilization control when the number inputted as the number of print copies to be made is larger than the predetermined reference value and also the inputted print data include image data and/or graphic data.

### BRIEF DESCRIPTION OF THE DRAWINGS

This and other objects and features of the present invention will be apparent from the following description with reference to the accompanying drawings, in which:

FIG. 1 is a schematic structural view of an image forming apparatus according to an embodiment of the present invention;

FIG. 2 is a block diagram of a control section of the image forming apparatus;

FIG. 3 is an illustration showing the content of a print job; and

FIG. 4 is a flowchart showing a procedure carried out by the control section.

### DETAILED DESCRIPTION OF THE PREFERRED EMBODIMENTS

Hereinafter, there will be described an image forming apparatus according to an embodiment of the present invention, with reference to the accompanying drawings.

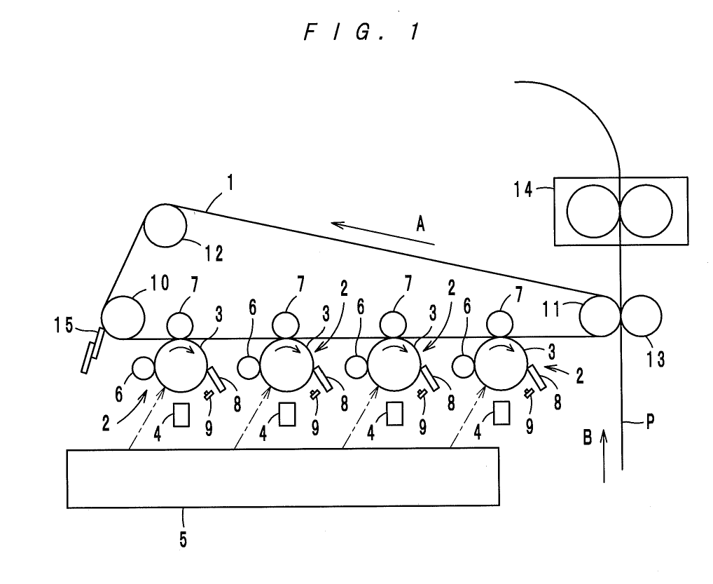

An image forming apparatus according to an embodiment of the present invention is formed as a tandem-type color printer, as illustrated in FIG. 1. In the color printer, an intermediate transfer belt 1 is placed in an endless manner, in the apparatus main body. The intermediate transfer belt 1 is wound around and supported by a driving roller 10, a driven roller 11 and a tension roller 12, and is driven to rotate in the direction of an arrow A.

Along a horizontal portion of the intermediate transfer belt 1, four image forming units 2 are placed in a row. These image forming units 2 basically have the same structure and are adapted to form yellow (Y), magenta (M), cyan (C) and black (K) toner images, respectively, in this order from the left side of FIG. 1. These image forming units 2 each include a drum-type electrophotographic photoreceptor 3 (which will be hereinafter referred to as a photosensitive drum 3) as a rotating image carrier. Around the photosensitive drum 3, there are placed a charger 4, a laser scanning optical device 5, a development device 6, a primary transfer device 7, a blade 8 for cleaning residual toner, and a charge eraser 9 for erasing residual charge. The processes for forming images on the photosensitive drums 3 using the aforementioned image forming elements is well known as an electrophotographic method and will not be described in detail.

Further, Y, M, C and K toner images which have been formed on the respective photosensitive drum 3 are transferred, in order, to the intermediate transfer belt 1 that is rotating in the direction of the arrow A (primary transfer), whereby a composite color image is formed on the intermediate transfer belt 1. Next, the composite image is transferred to a recording sheet P being fed in the direction of an arrow B through an electric field applied thereto from a secondary transfer device 13 (secondary transfer). After the secondary transfer, the recording sheet P is subjected to a heating treatment in a fixing device 14, whereby the toner image is fixed on the recording sheet P. Then, the recording sheet P is ejected onto a tray (not shown). Further, residual toner on the intermediate transfer belt 1 is removed by a cleaning device 15.

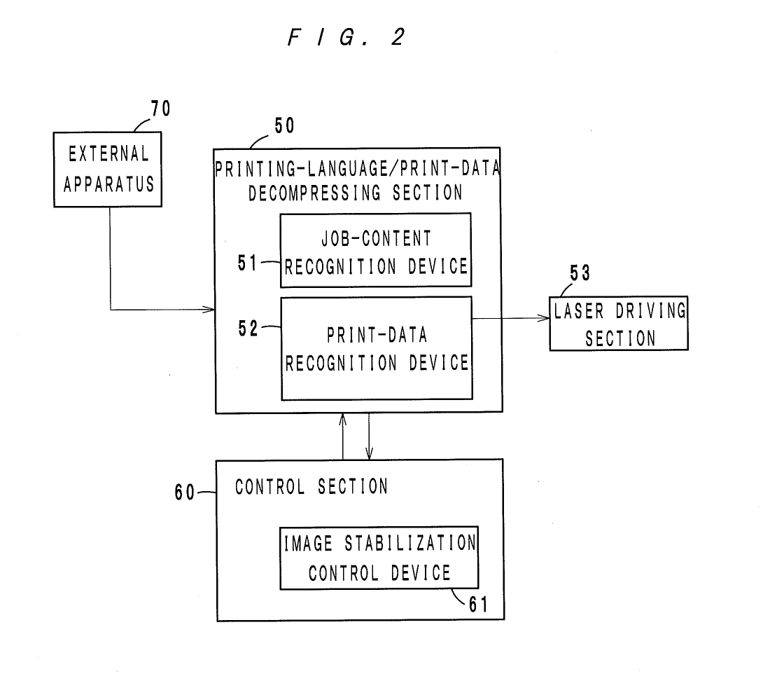

A control device in the color printer will be hereinafter described. In the following paragraphs, only the sections relating to the present invention will be described. The control device has a printing-language/print-data decompressing section 50 and a control section 60 for controlling the printer main body, as illustrated in FIG. 2. The printing-language/print-data decompressing section 50 is adapted to decompress print data inputted thereto from an external apparatus 70, such as a computer, into data to be transmitted to a laser driving section 53 in the laser scanning optical device 5.

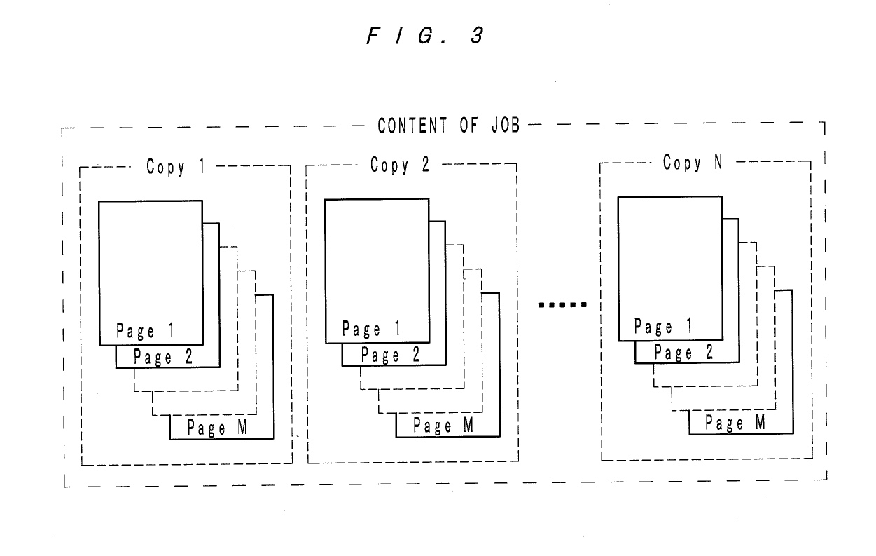

The printing-language/print-data decompressing section 50 includes a job-content recognition device 51 and a print-data recognition device 52. The job-content recognition device 51 recognizes the number of pages of a document and the number of print copies to be made in a single job from the data transmitted from the external apparatus 70 and judges the number of printed sheets to be made. The job-content recognition device 51 particularly judges whether the number of print copies to be made is larger or smaller than a predetermined reference value Th. The Data about the number of copies to be made and the like are transmitted to the control section 60. The print-data recognition device 52 judges whether or not print data transmitted from the external apparatus 70 include image data, graphic data and text data. The content of a print job is constituted by the number of pages of print data corresponding to a document and the number of copies to be made, as illustrated in FIG. 3.

The control section 60 is adapted to control a mechanical system and an electrical system in the printer main body and includes an image stabilization control device 61. The image stabilization control is carried out in the following ways: test patterns are formed on the photosensitive drums 3 under predetermined conditions; the test patterns are transferred to the intermediate transfer belt 1; the transferred images are optically detected so that the image densities thereof are checked; and all or some of the charge potential, the development bias potential and the exposure amount of the photosensitive members to laser are adjusted so that predetermined densities can be achieved. This image stabilization control is well known and is conventionally carried out. In a color printer, in addition to the density adjustment, it is necessary to carry out color registration so as to place images of respective colors accurately one upon another on the intermediate transfer belt 1. Further, the color registration can be carried out separately from the image stabilization control according to the present embodiment.

The image stabilization control device 61 ordinarily sets the intervals among executions of the image stabilization control to a predetermined period S2. However, in a case where the number inputted as the number of print copies to be made is larger than the predetermined reference value Th and the inputted print data include image data and/or graphic data, the image stabilization control device 61 sets the intervals among executions of the image stabilization control to a period S1 shorter than the period S1 so that the printed images can be prevented from varying in color.

The period S2 that the image stabilization control device 61 ordinarily sets as the intervals among executions of the image stabilization control is relatively long, in view of the fact that print data ordinarily include character data in most part thereof. The predetermined period S2 is determined, considering printing productivity, toner consumption and the period at which variations in image density are likely to occur in a case of outputting character data. In a case where there is a possibility of conspicuous color variations in the middle of a single job, that is, in a case where the number of print copies to be made is larger than the predetermined reference value Th, and also, the inputted print data include image data and/or graphic data, the intervals among executions of the image stabilization control are set to be the period S1 that is shorter than the period S2. This suppresses an increase in toner consumption and a reduction in printing productivity and also prevents successively outputted printed images from varying in color.

More specifically, the period S2 that is ordinarily set as the intervals among executions of the image stabilization control corresponds to, for example, printing 200 A4-sized sheets. Further, different values are used as the period S2 between the time immediately after replacement of any of the photosensitive drums 3, the development devices 6 and other printing components with a new one and the time when the replaced component has warmed up after operation for a certain time. The period S1 that is set to suppress variations of printed images in color corresponds to, for example, printing 20 A4-sized sheets. Further, the reference value Th for the number of print copies, which is the criterion for the setting of the period S1, is, for example, 5. The value of the period S1 may be changeable by an operator. It is to be noted that these values are merely examples.

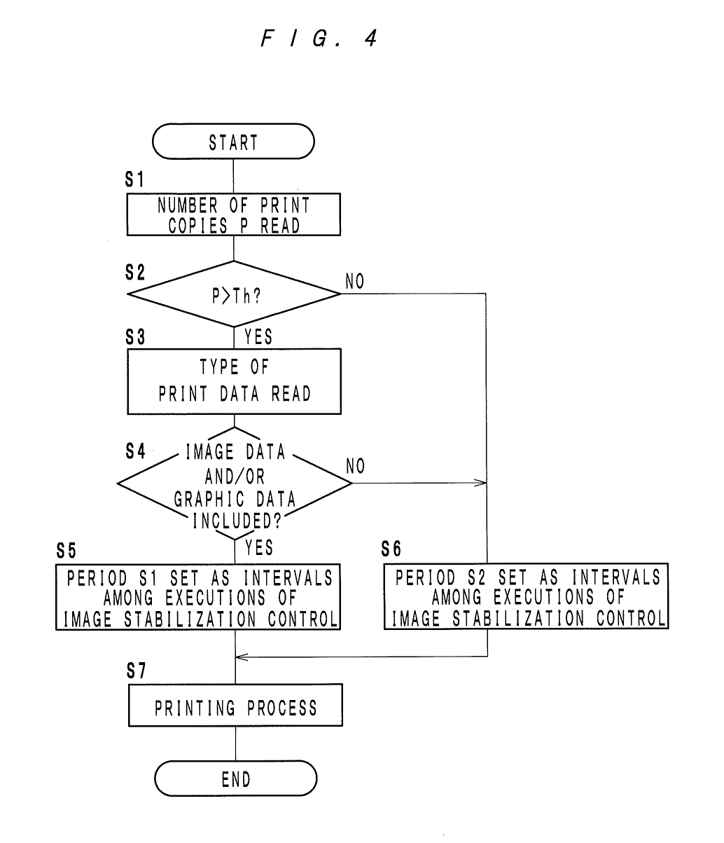

Hereinafter, there will be described a control procedure carried out by the image stabilization control device 61, with reference to a flowchart in FIG. 4. When print data is transmitted from the external apparatus 70, the image stabilization control device 61 first reads data about the number P of print copies to be made (step S1). The number P of print copies to be made is compared with the reference value Th, and if the number P is larger than the value Th (YES at step S2), the image stabilization control device 61 reads data about the type of the print data transmitted from the external apparatus 70, on a page-by-page basis (step S3).

If the print data include image data and/or graphic data (YES at step S4), the period S1 is set as the intervals among executions of the image stabilization control (step S5), and a printing process is performed (step S7).

On the other hand, if the number P is not larger than the value Th (No at step S2) or if the print data include neither image data nor graphic data (No at step S4), the period S2 is set as the intervals among executions of the image stabilization control (step S6), and the printing process is performed (step S7). Further, the determination as to whether or not the print data include image data and/or graphic data may be made, based on data about the type of the page read from attribute information included in the print data or alternatively based on the ratio of medium tone portions recognized by analysis of image data included in the print data.

Further, the image forming apparatus is not necessarily a color printer, and may be a monochromatic printer, a copying machine or a multi-function machine having a communication function such as a facsimile.

In the image forming apparatus according to the above-described embodiment, an increase in toner consumption and a reduction in printing productivity can be suppressed, and successively outputted printed images can be prevented from varying in color.

Although the present invention has been described in connection with the preferred embodiments above, it is to be noted that various changes and modifications are possible to those who are skilled in the art. Such changes and modifications are to be understood as being within the scope of the present invention.

What is claimed is:

1. An image forming apparatus comprising;
a job-content recognition device for judging whether a number inputted as the number of print copies to be made is larger or smaller than a predetermined reference value;
a print-data recognition device for judging whether or not inputted print data include image data and/or graphic data; and
a control device for controlling executions of image stabilization control in a printing section; wherein
the control device sets a predetermined period as intervals among executions of the image stabilization control, and sets a period shorter than the predetermined period as the intervals among executions of the image stabilization control when the number inputted as the number of print copies to be made is larger than the predetermined reference value and also the inputted print data include image data and/or graphic data.

2. The image forming apparatus according to claim 1, further comprising:
a photoreceptor;
a charger for charging a surface of the photoreceptor;
an exposure device for exposing the surface of the photoreceptor to a specified exposure amount so as to form an electrostatic latent image on the surface of the photoreceptor; and
a development device for supplying toner to the surface of the photoreceptor so as to develop the electrostatic latent image into a toner image.

3. The image forming apparatus according to claim 2,
wherein the image stabilization control comprises checking an image density, and adjusting at least one of a charge potential, a development bias potential and the exposure amount of the photoreceptor so as to achieve a predetermined density.

4. The image forming apparatus according to claim 2, further comprising:
a plurality of development devices that respectively store toner of mutually different colors; and
the image stabilization control includes color registration control.

5. The image forming apparatus according to claim 2, wherein the control device uses different values as the predetermined period between at a time immediately after replacement of the photoreceptor or the development device and a time after operation of the replaced photoreceptor or development device for a specified time.

6. The image forming apparatus according to claim 1, wherein the print-data recognition device reads data about a type of image from attribution information included in the print data, and judges whether or not the print data include image data and/or graphic data based on the data about the type of image.

7. The image forming apparatus according to claim 1, wherein the print-data recognition device analyzes image data included in the print data to calculate a ratio of medium tone portions in an image, and judges whether or not the print data include image data and/or graphic data based on the calculated ratio.
